(19) United States
(12) Patent Application Publication
(10) Pub. No.: US 2010/0062392 A1
(43) Pub. Date: Mar. 11, 2010

(54) Rotary gingival cord packer

(76) Inventor: Lon Latiolais, Georgetown, TX (US)

Correspondence Address: THE MATTHEWS FIRM, 2000 BERING DRIVE, SUITE 700, HOUSTON, TX, 77057, US

(21) Appl. No.: 12/283,104

(22) Filed: Sep. 9, 2008

(51) Int. Cl. A61C 3/00

(52) U.S. Cl. 433/141

(57) ABSTRACT

A dental apparatus usable to place cord beneath a gum line and related methods of use are disclosed herein. The apparatus includes a handle with an angled shank disposed on an end. A circular rotatable member is connected to the tip of the shank. A second angled shank with a second circular rotatable member connected thereon can be disposed on the opposing end of the handle. In operation, the edge of one of the circular rotatable members is placed in contact with a cord surrounding a tooth, and the edge is moved along the length of the cord, such that contact between the edge and the cord causes the circular rotatable member to rotate, while the other portions of the apparatus are moved laterally during use. The cord is thereby placed beneath the gum line while contact between the apparatus and surrounding teeth and gums can be minimized.

### FIELD

The present embodiments relate generally to a dental apparatus for placing cord beneath a gum line and related methods of use, and further, to an apparatus for moving tissue on the body, such as cuticle tissue.

### BACKGROUND

When performing restorative dental procedures or other dental operations, it is often necessary to obtain an impression of one or more teeth. To obtain a suitable impression of a tooth, impression material must be able to flow slightly beneath the gum line.

Typically, gingival tissue, saliva, and/or gingival bleeding can block access of the impression material to portions of the tooth below the gum line. A gingival cord is normally used to temporarily retract portions of the gum from one or more teeth to ensure access of the impression material to all necessary portions of the tooth. The cord is placed closely around a tooth, and must then be packed around the base of the tooth to separate the gingival tissue from the tooth.

Conventionally, this procedure is performed using a narrow dental instrument with a blunted tip to forcefully push the cord between the tooth and gum tissue. Use of a conventional gingival cord packing tool can be a time-intensive process, can cause discomfort to a patient, and can cause trauma and damage to the tooth and/or the gum. Damaged gum tissue can bleed, hindering the ability of impression material to flow below the gum line to obtain an impression of the tooth. Further, damaged gum tissue can recede, causing sensitive areas of the tooth to become exposed and hindering the effectiveness of restorative dental procedures, such as crowns and bridges.

Other instruments used to pack a cord into the gingival tissue surrounding a tooth include tools having narrow members that slide or scrape along the surface of a tooth, which can cause discomfort or pain, and can also cause damage to the tooth and surrounding gum tissue.

A need exists for a dental apparatus that is usable to place cord beneath a gum line quickly, without causing trauma or discomfort.

A further need exists for a dental apparatus that can gently move along the length of a cord around a tooth while minimizing scraping or contact with the tooth, thereby minimizing the possibility of damage or discomfort.

A need also exists for a dental apparatus that can quickly and efficiently place a cord beneath a gum line, without requiring time-intensive packing or scraping methods.

The present embodiments meet these needs.

### SUMMARY

The present embodiments relate to a dental apparatus for placing cord beneath a gum line.

The apparatus can include an elongate handle having an angled shank disposed on an end. The angled shank can be selectively oriented to facilitate access to one or more portions of the gum line. In an embodiment, the angled shank can have a diameter less than that of the elongate handle, for facilitating access and maneuverability within the mouth.

A circular rotatable member can be connected to the tip of the angled shank. In an embodiment, the circular rotatable member can have a diameter less than or equal to four millimeters. The thickness of the circular rotatable member can be selected to facilitate fitting, at least partially, between teeth.

In an embodiment, a second angled shank can be disposed on the opposite end of the elongate handle, having a second circular rotatable member of connected thereon. The second circular rotatable member can be of similar size and construction as the first circular rotatable member.

The second circular rotatable member can be disposed perpendicularly in relation to the first circular rotatable member, thereby enabling each end of the apparatus to selectively provide easy access to various portions of the mouth.

In an embodiment, the angles of each angled shank can be selected such that each shank facilitates access to differing portions of the gum line.

The circular rotatable members are usable to engage and roll along a gingival cord, quickly and efficiently placing the cord beneath a gum line in a single motion. Conversely, conventional packing tools require multiple strokes in a poking or scraping manner to pack a cord into the gum.

The circular rotatable members are further usable to place the cord beneath the gum line while minimizing the risk of contact with gum tissue, thereby minimizing the risk of patient discomfort, trauma, and/or bleeding. Additionally, the circular rotatable members are usable to place the cord beneath the gum line without contacting the tooth, further reducing patient discomfort and possible damage to the tooth.

The present embodiments also relate to methods for placing gingival cord beneath a gum line.

A gingival cord is first placed around a tooth. A dental apparatus having a circular rotatable member, as described above, is provided.

The edge of the circular rotatable member is placed against the gingival cord, and the edge is then moved along the gingival cord. Contact between the edge of the circular rotatable member and the cord causes the circular rotatable member to rotate, such that the apparatus rolls along the cord, gently placing the cord between the gum tissue and the tooth, rather than forcefully packing the cord into place.

While moving the circular rotatable member along the gingival cord, contact between the circular rotatable member and the tooth can be minimized, thereby preventing patient discomfort and damage to the tooth. Ideally, the dental apparatus can be used to place a cord beneath a gum line while contacting only the cord, without contacting the gums or teeth.

When using a dental apparatus having a second circular rotatable member connected to a second angled shank, perpendicularly disposed in relation to the first circular rotatable member, the method can include selectively using the second circular rotatable member to move along the cord when the angle of the second circular rotatable member would facilitate placement of the cord.

The present embodiments further relate to an apparatus usable to move tissue on a body, such as by pushing cuticle tissue to expose fingernails or toenails for removal.

The apparatus can include an elongate handle having angled shanks disposed on each end, as described previously. A circular rotatable member can be connected to the tip of each shank. One or both of the angled shanks can have diameters less than that of the elongate handle.

In an embodiment, the circular rotatable members can be perpendicularly disposed in relation to one another. In a further embodiment, the circular rotatable members can have a diameter greater than or equal to four millimeters.

### BRIEF DESCRIPTION OF THE DRAWINGS

In the detailed description of the embodiments presented below, reference is made to the accompanying drawings, in which:

FIG. 1 depicts a side view of an embodiment of the present dental apparatus.

FIG. 2 depicts a perspective view of an end of the apparatus of FIG. 1.

FIG. 3 depicts a perspective view of the end of the apparatus opposite the end depicted in FIG. 2.

The present embodiments are detailed below with reference to the listed Figures.

### DETAILED DESCRIPTION OF THE EMBODIMENTS

Before explaining the present embodiments in detail, it is to be understood that the embodiments are not limited to the particular descriptions and that the embodiments can be practiced or carried out in various ways.

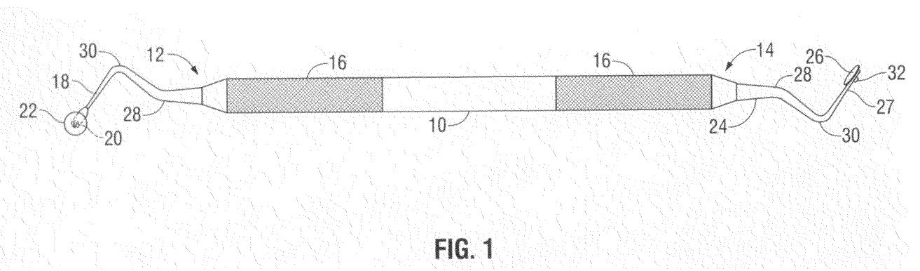

Referring now to FIG. 1, a side view of an embodiment of the present dental apparatus is depicted.

FIG. 1 depicts an elongate handle (10) having a first end (12) and a second end (14). The elongate handle (10) is shown having a generally cylindrical shape with frustoconical ends and knurled areas (16) for facilitating manual manipulation of the apparatus. Other types of grip and/or non-slip surfaces can also be used in addition to or in lieu of the knurled areas (16). In an embodiment, the elongate handle (10) can be approximately 10.8 centimeters in length and about 0.6 centimeters in diameter. However, it should be noted that the dimensions of the present dental apparatus can vary depending on the preferences of the dentist, features of the tooth or patient, location of the tooth within the mouth, or other characteristics.

A first angled shank (18) is shown connected to the first end (12) of the elongate handle (10). The first angled shank (18) has a tip (20), which is connected to a first circular rotatable member (22).

A second angled shank (24) is shown connected to the second end (14). The second angled shank (24) has a tip (27), which is connected to a second circular rotatable member (26).

Each angled shank (18, 24) is depicted having a first angular bend (28) of approximately 150 degrees in relation to the axis of the elongate handle (10), and a second angular bend (30) of approximately 90 degrees in the direction opposite that of the first angular bend. Each angled shank (18, 24) is shown having angular bends in opposition to one another, that position each angled shank (18, 24) with an opposing orientation with respect to the elongate handle (10). However, in an embodiment, the angled shanks (18, 24) can have angular bends that position each angled shank (18, 24) on the same side of the elongate handle (10).

The location of the angular bends (28, 30) and the size of the angles can vary depending on the preferences of the dentist, the shape of a patient's mouth, the location of one or more teeth, or other similar characteristics. The size and location of the angular bends (28, 30) can be selected to facilitate access to various parts of the mouth and gum line.

Each circular rotatable member (22, 26) is depicted having a diameter of approximately 4 millimeters, and a thickness of approximately 1 millimeter, however circular rotatable members of other sizes are also usable. The diameter and/or thickness of the circular rotatable members (22, 26) can be selected to facilitate at least partial entry of the circular rotatable members (22, 26) into spaces between teeth.

The circular rotatable members (22, 26) are shown attached to their respective tips (20, 27) using pins, of which a pin (32) attached to the second tip (27) is visible. The pins (32) are contemplated to provide the circular rotatable members (22, 26) with 360 degrees of free rotation about their central axes, while the attached angled shanks (18, 24) remain stationary or are moved in lateral directions as the apparatus is used.

Other fastening members that provide the circular rotatable members (22, 26) with free rotation while the angled shanks (18, 24) remain stationary or move laterally can also be used.

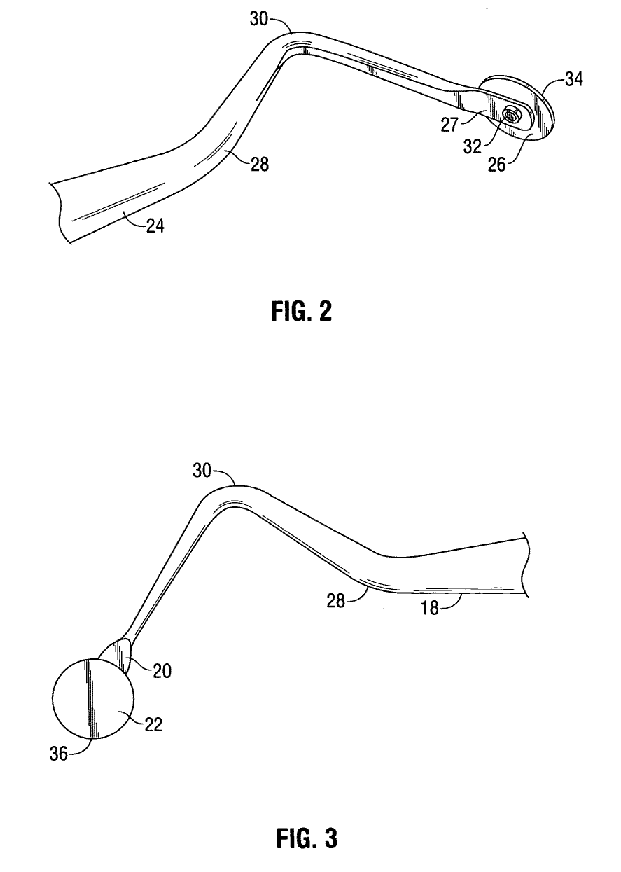

Referring now to FIG. 2, a perspective view of the second angled shank (24) is shown.

The second angled shank (24) is depicted having first angled bend (28) and second angled bend (30), as described previously. The second angled shank (24) terminates in a tip (27), which is depicted having a width slightly greater than that of the remainder of the second angled shank (24), and a thickness slightly less than that of the second angled shank (24), for accommodating the pin (32).

The pin (32) is shown, rotatably securing the second circular rotatable member (26) to the second angled shank (24).

The second circular rotatable member (26) is shown having an edge (34), which is usable to roll along a gingival cord or other surface as the second circular rotatable member (26) rotates, while the second angled shank (24) is moved laterally. The edge (34) can thereby be used to move along the length of a gingival cord, whereby the second circular rotatable member (26) is rotated through contact with the gingival cord, without contacting the adjacent gum tissue or tooth.

Referring now to FIG. 3, the first angled shank (18) is depicted, having a first angled bend (28) and a second angled bend (30), as described previously. The first angled shank (18) terminates in a tip (20), which can be substantially similar in shape and have substantially similar dimensions to the opposing tip (27, depicted in FIG. 2), and can be perpendicularly disposed in relation to the opposing tip.

The tip (20) accommodates a pin (not visible in FIG. 3), which rotatably secures the first circular rotatable member (22) to the first angled shank (18) in a substantially similar manner to the securing of the second circular rotatable member to the second angled shank, as shown in FIG. 2. The first circular rotatable member (22) is secured in a perpendicular relationship to the second circular rotatable member (26, depicted in FIG. 2).

The first circular rotatable member (22) has an edge (36), which is usable to roll along a gingival cord or other surface as the first circular rotatable member (22) rotates, while the first angled shank (18) moves laterally. The perpendicular relationship between the first and second circular rotatable members enables each angled shank to easily reach differing locations around a tooth for placing a cord beneath the gum line.

The circular rotatable members (22, 26) are also usable to move body tissue, such as cuticle tissue, for various general medicine, podiatric, and/or cosmetic purposes, while minimizing contact between the apparatus and parts of the body that are not being moved by the rotatable members, such as the nail bed.

While these embodiments have been described with emphasis on the embodiments, it should be understood that within the scope of the appended claims, the embodiments might be practiced other than as specifically described herein.

What is claimed is:

1. A dental apparatus for placing cord beneath a gum line, the dental apparatus comprising:
an elongate handle;
a first angled shank disposed on a first end of the elongate handle, the first angled shank comprising a tip; and
a first circular rotatable member connected to the tip of the first angled shank.

2. The dental apparatus of claim 1, further comprising:
a second angled shank disposed on a second end of the elongate handle, the second angled shank comprising a tip; and
a second circular rotatable member connected to the tip of the second angled shank.

3. The dental apparatus of claim 2, wherein the first circular rotatable member is perpendicularly disposed in relation to the second circular rotatable member.

4. The dental apparatus of claim 1, wherein the first angled shank has a diameter less than that of the elongate handle

5. The dental apparatus of claim 1, wherein the first circular rotatable member has a diameter less than or equal to four millimeters.

6. The dental apparatus of claim 1, wherein the first circular rotatable member has a thickness selected to fit between teeth.

7. The dental apparatus of claim 1, wherein the first angled shank comprises at least one angle oriented to facilitate access to the gum line.

8. The dental apparatus of claim 2, wherein the first angled shank comprises at least a first angle oriented to facilitate access to at least a portion of the gum line and the second angled shank comprises at least a second angle differing from said first angle for facilitating access to at least a second portion of the gum line.

9. A method for placing gingival cord beneath a gum line, the method comprising the steps of:
placing a gingival cord around a tooth;
providing a dental apparatus comprising a first circular rotatable member connected to a first angled shank;
placing an edge of the first circular rotatable member in contact with the gingival cord; and
moving the edge along the gingival cord, wherein contact between the edge and the gingival cord causes the first circular rotatable member to rotate, thereby placing the gingival cord beneath the gum line.

10. The method of claim 9, wherein the dental apparatus further comprises a second circular rotatable member connected to a second angled shank, wherein the first circular rotatable member is perpendicularly disposed in relation to the second circular rotatable member, and wherein the method further comprises the steps of placing the edge of the second circular rotatable member against the gingival cord and moving the second circular rotatable member along the gingival cord.

11. The method of claim 9, wherein the step of moving the edge along the gingival cord further comprises minimizing contact between the first circular rotatable member and the tooth.

12. An apparatus for moving tissue on the body, the apparatus comprising:
an elongate handle comprising a first end and a second end;
a first angled shank disposed on the first end, the first angled shank comprising a tip;
a second angled shank disposed on the second end, the second angled shank comprising a tip;
a first circular rotatable member connected to the tip of the first angled shank; and
a second circular rotatable member connected to the tip of the second angled shank.

13. The apparatus of claim 12, wherein the first circular rotatable member is perpendicularly disposed in relation to the second circular rotatable member.

14. The apparatus of claim 12, wherein the first angled shank, the second angled shank, or combinations thereof, have a diameter less than that of the elongate handle.

15. The apparatus of claim 12, wherein the first circular rotatable member, the second circular rotatable member, or combinations thereof, have a diameter greater than or equal to four millimeters.

16. The apparatus of claim 12, wherein the tissue on the body comprises cuticle tissue.
